(19) United States
(12) Patent Application Publication
(10) Pub. No.: US 2011/0105166 A1
(43) Pub. Date: May 5, 2011

(54) Method and Arrangement in a Telecommunication System

(75) Inventors: Ning He, Sollentuna (SE); Bo Hagerman, Tyreso (SE)

(73) Assignee: Telefonaktiebolaget LM Ericsson (publ)

(21) Appl. No.: 12/997,059

(22) PCT Filed: Jun. 12, 2008
(86) PCT No.: PCT/EP08/57406

§ 371 Date: Dec. 9, 2010

(51) Int. Cl. H04B 7/00

(52) U.S. Cl. 455/507

(57) ABSTRACT

In a method of radio link handling in a radio base station (RBS) in a telecommunication system, said radio base station (RBS) supporting a plurality of mobile user equipment (UE) and comprising a plurality of antenna arrangements each associated with a respective determined cell coverage area. Performing the steps of actively determining (20) a respective local receive active set of cells or antennas for each of at least a subset of said plurality of mobile user equipment (UE). Finally, receiving and detecting (30) signals from each mobile user equipment (UE) jointly utilizing each said determined local receive active set.

### TECHNICAL FIELD

The present invention relates to telecommunication systems in general, and specifically to a method and arrangement for increased spatial diversity in radio base stations in such systems.

### BACKGROUND

For radio communications, a site normally includes area coverage of several different service areas, e.g. a site (Radio Base Station, RBS) includes coverage of 3-cells/sectors (see FIG. 1). For simplicity reasons the coverage area of each cell is represented by a circle. However, in reality the coverage area is represented by a more complex combination of antenna lobes. For each cell/sector at the site, usually a separate deployed antenna arrangement covers the required cell/sector service area. Antenna signals from all cells/sectors are available at the RBS. Each antenna arrangement can comprise one or a plurality of separate antennas.

For seamless mobility, the antenna patterns of neighboring respective cells are commonly designed to overlap between cells/sectors. For a UE (User Equipment) connected to a cell/sector the antenna arrangement for that specific cell/sector receives and uses the received signals for the detection of the UE transmitted signals. Typically in each cell/sector, two receive antennas (receive diversity) are used for receiving uplink signals. When the UE moves into the overlap area between neighboring respective cells/sectors and detects signals from an adjacent cell/sector with a signal level within a predefined threshold set by the system, a new connection will be established, i.e. communication established over at least two cells/sectors. The threshold may be an absolute value or a relative value.

For example, in the UMTS WCDMA standard, the UE measures on downlink neighboring cells and requests UTRAN to add the cell(s) which fulfills the quality criterion, i.e. the downlink UE received power level(s) of the neighboring cell(s) is (are) above the predefined threshold. This is called radio link addition and the cells with activated radio links are included in the active set in the WCDMA terminology. When the UE and the UTRAN are communicating through more then one cell (the active set larger than 1), more spatial diversity gain is obtained which is a potential for improved advanced receive signal detection.

However, the radio conditions for the uplink are not always the same as for the downlink. In addition, the above-described procedure of radio link addition execution results in such a long delay that the uplink power is not utilized efficiently.

Therefore, there is a need for methods and arrangements that utilize the uplink radio resources more efficiently.

### SUMMARY

An object of the present invention is to reduce or eliminate the above-described problems.

A specific object is to provide a method in a radio base station that enables utilizing uplink powers more efficiently.

Basically, in a method of radio link handling in a radio base station RBS in a telecommunication system, said radio base station RBS supporting a plurality of mobile user equipment UE and comprising a plurality of antenna arrangements each associated with a respective determined cell coverage area. Performing the steps of actively determining a respective local receive active set of cells or antennas for each of at least a subset of said plurality of mobile user equipment UE, and receiving and detecting signals from each mobile user equipment UE jointly utilizing each said determined local receive active set.

### ADVANTAGES OF THE PRESENT INVENTION INCLUDE

Improved data coverage for specific directions within the service area, independent of used service (data rate) of the UEs as a consequence of the increased diversity gain.

Increased spatial diversity and/or improved spatial interference suppression/cancellation.

Improves received performance for high bit rates and/or user capacity and/or coverage and/or cell edge bit rates.

Reduced complexity of the radio base station.

### BRIEF DESCRIPTION OF THE DRAWINGS

The invention, together with further objects and advantages thereof, may best be understood by referring to the following description taken together with the accompanying drawings, in which:

FIG. 1 illustrates cell/sector coverage of a radio base station;

FIG. 2 illustrates a general telecommunication system in which the present invention can be implemented;

FIG. 3 illustrates a flow diagram of an embodiment of a method according to the present invention;

FIG. 4 illustrates a flow diagram of a further embodiment of a method according to the present invention;

FIG. 5 illustrates an example of the use of an embodiment of the present invention;

FIG. 6 illustrates an embodiment of an arrangement according to the present invention.

### ABBREVIATIONS

### BS Base Station

### CDMA Code Division Multiple Access

### EUL Enhanced UpLink

### GRAKE Generalized RAKE

GSM Global System for Mobile communications

### HSPA High-Speed Packet Access

### HSUPA High-Speed Uplink Packet Access

### HW HardWare

### IC Integrated Circuit

### LTE Long-Term Evolution

### MMSE Minimum Mean Square Error

### MUD Multi User Diversity

### QoS Quality of Service

### RBS Radio Base Station

### RNC Radio Network Controller

### SNR Signal to Noise Ratio

### SINR Signal to Interference and Noise Ratio

### UE User Equipment

### UMTS Universal Mobile Telecommunications System

### WCDMA Wideband Code Division Multiple Access

### WiMAX Worldwide Interoperability for Microwave Access

### DETAILED DESCRIPTION

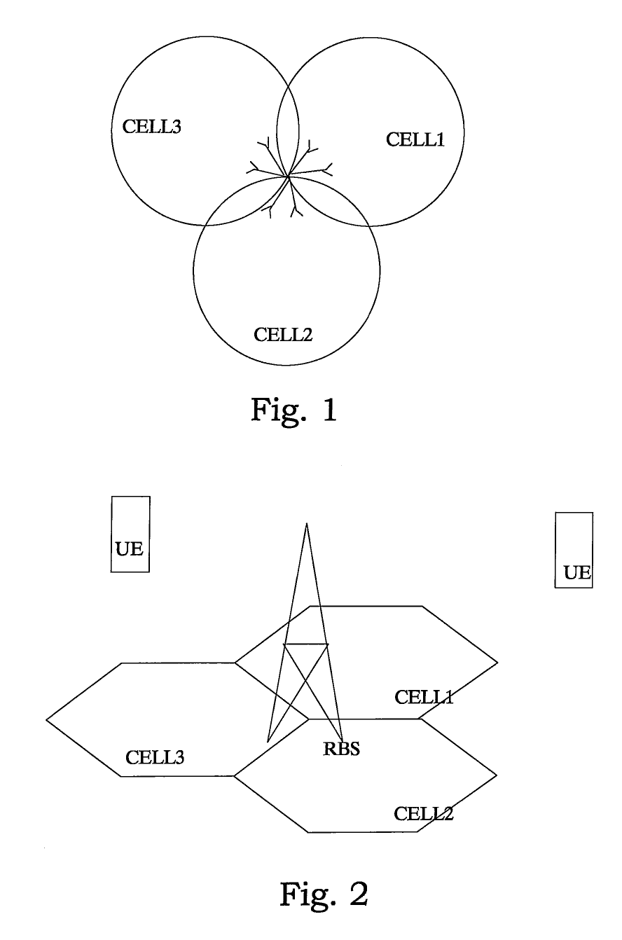

The concept of the present invention can be applied to any communication system, e.g. WCDMA, WiMAX, LTE, GSM, CDMA-2000, etc. However, for simplicity reasons, the present invention will be described in the context of a WCDMA system. For a general illustration of a telecommunication system, see FIG. 2

The present invention facilitates active selection of uplink multi-cell/sector reception by letting all cells/sectors in the same base station (site) measure the powers/quality from all UEs or from a pre-defined set of UEs in a defined range periodically. Further, actively determine if to jointly receive and detect the UE signals from multiple cells/sectors, which have proper signal level/quality creating an opportunity for more advanced receiver activation creating substantially improved performance.

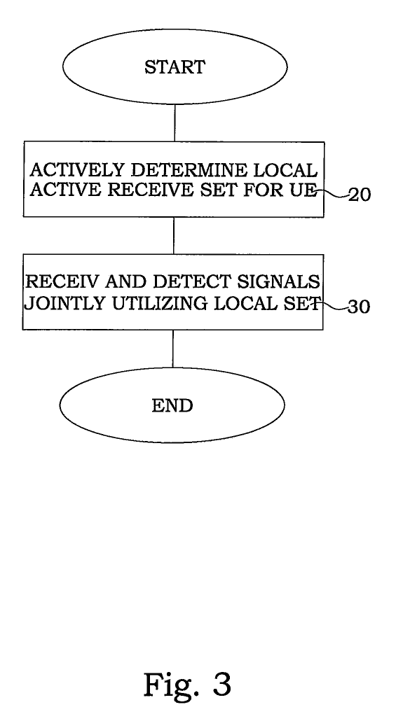

A basic embodiment of a method according to the present invention will be described with reference to FIG. 3. In short, the method enables managing or handling radio links in a site or radio base station RBS in a telecommunication system. In order to achieve this the radio base station RBS is configured to support a plurality of mobile user equipment UE and includes a plurality of antenna arrangements. Each such antenna arrangement deploys or is associated with a respective determined cell coverage area. Accordingly, the method includes the steps of actively determining 20 a respective local receive active set of cells or antenna arrangements for each of at least a subset of the plurality of mobile user equipment UE. Subsequently, receiving and detecting 30 signals from each mobile user equipment UE by jointly utilizing each said determined local receive active set.

The above mentioned steps are all performed locally within the radio base station, preferably without any signalling to other parts of the telecommunication system. In addition, the steps are performed at a very short time scale, preferably within the range of one transmission time interval (TTI).

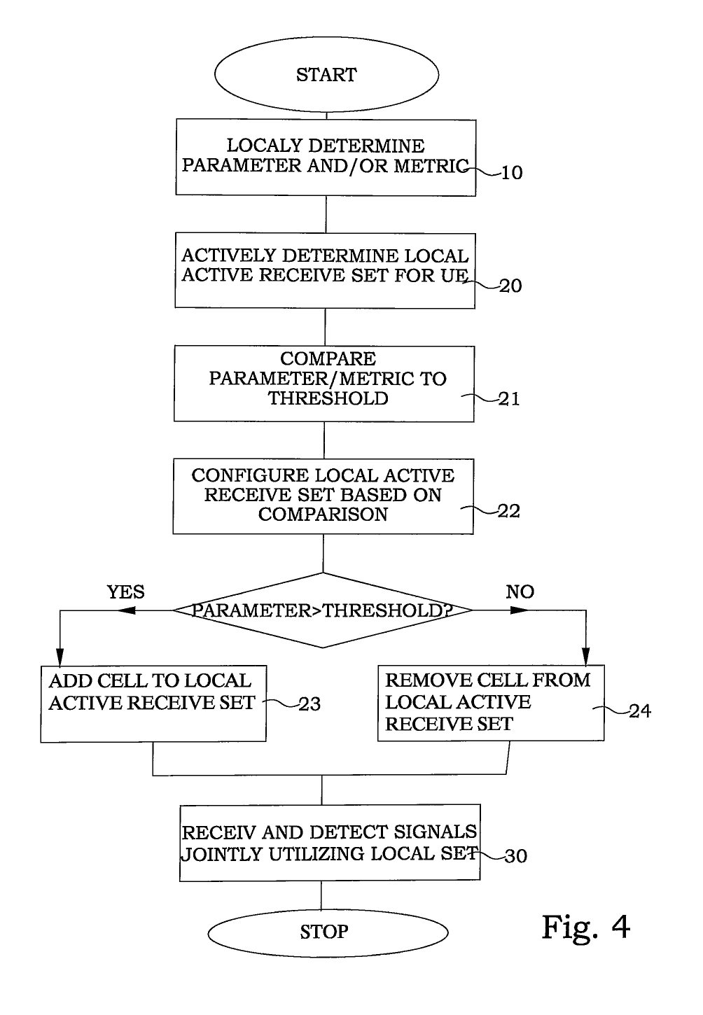

Also, with reference to FIG. 4, an embodiment of the present invention comprises the further step of locally determining 10, for all of the cells associated with the radio base station, a parameter or a set of parameters for at least said subset of the plurality of mobile user equipment UE, and actively determining 20 the respective local receive active set of the cells or antennas for each of those mobile user equipment UE of the subset based on the determined parameter or set of parameters. Those parameters are typically known in the radio base station, and can be represented by scheduling information, receiver algorithms etc.

In addition to utilizing already known parameters, it is possible to in a corresponding manner determine a metric or set of metrics based on the uplink signal for each UE. This can typically be performed by measurements of the uplink signal.

In a specific embodiment, the active receive set determination step can be performed according to a two step process. This is performed by comparing 21 the determined metric and/or parameter and/or set of metrics and/or set of parameters for each cell and UE with a predetermined threshold value, and configuring 22 the local receive active set based on that or those comparisons. It is possible to perform the determining step based on known parameters in the radio base station and/or metrics based on the received uplink signal(s).

The configuring step 22 can be further adapted to comprise adding 23 a cell to the determined local receive active set if the corresponding determined metric and/or parameter exceeds said predetermined threshold value, and removing 24 a cell from the determined local receive active set if the corresponding metrics and/or parameters do not exceed said predetermined threshold value.

According to a further embodiment, the method includes that the received power/quality of all UEs currently connected to the RBS periodically are locally determined or measured for all cells/antennas supported by the RBS, independent of which RBS cells(s) the active set includes in the same RBS. As complement to the periodically measurements, event driven utilizing EUL layers, a local receive active set is created in the RBS for each connected UE. When a UE signal is observed in a cell currently not in the active set, having a good radio link quality, this cell will actively be selected/added to join the cell(s) in the local receive active set to jointly receive and detect the signals from this UE. The cells belonging to the local receive active set and not in the active set will be detached from the UE local receive active set when the observed power/quality falls below a given criterion. The selection for adding/removing can be based on more or less fast decisions, based on everything between a momentary measurement value per radio time slot to any kind of filtering and/or averaging/smoothing of measurement values.

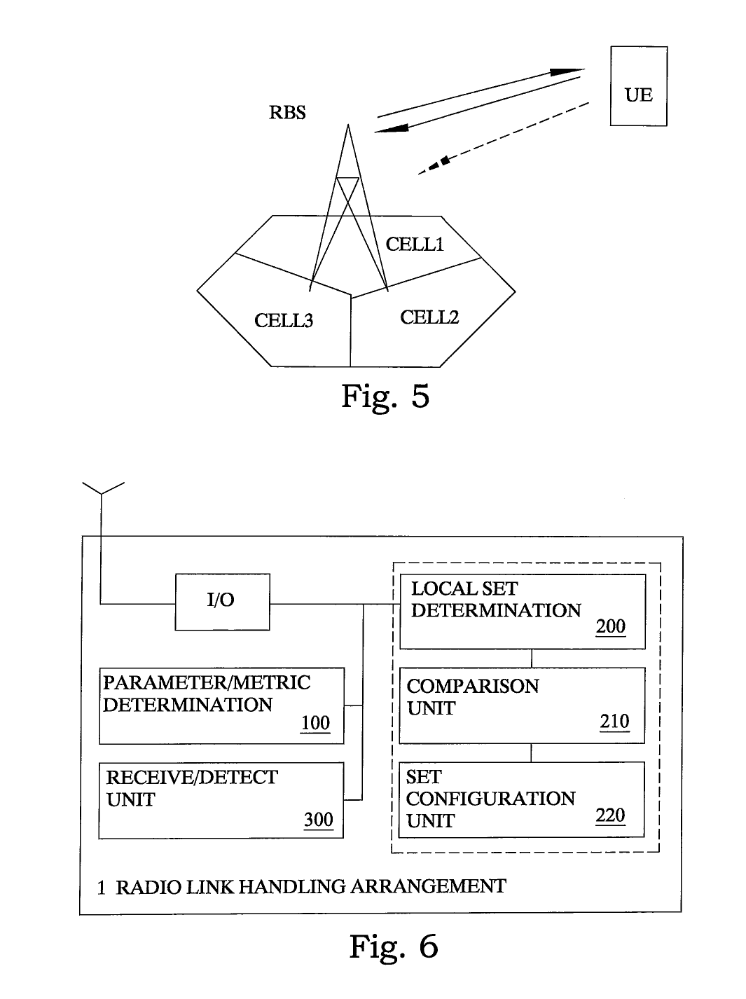

An example is illustrated in FIG. 5. A mobile user equipment UEₖ is currently being served by cell or sector 1. Cell or sector 2 actively measure all UEs in the desired region and determined UEₖ having good quality, e.g. the received power level is above a predefined threshold by comparing the measured power from cell 1 for the same UE. An active decision to add cell 2 to the local receive active set for the UEₖ associated to cell 1 and joint detection of the signals from the local receive active set of UEₖ is performed. On downlink, only cell 1 is transmitting since cell 2 is not in the active set.

The step of determining the parameters or metrics can be continuously, aperiodically, periodically and/or event driven. Preferably, the parameter/metric is determined at least once every TTI to enable quick adaptation to changes in received quality, movement of UE etc. examples of useable measurement metrics can be SNR, SINR, received signal strength, interference power levels etc. Both or either of absolute or relative values can be utilized.

To further aid higher protocol level decisions, the determined local receive active set for each mobile user equipment UE, or statistics of all or subset of UE selections, can be reported to a node in the system.

Proper reuse of adjacent cell antennas in any receiver would obtain spatial diversity gains. With advanced algorithms like interference cancellation, diversity gains would lead to better and more reliable cancellation results. With advanced algorithms for interference suppression, increased number of antennas would lead to increased number of interferers being able to suppress. One example is if the target UE of interest to detect is located in the part of the antenna overlapping area, while all scheduled EUL or high data rate UE's which create the substantial part of the interference are located in the original cell and no such users are scheduled in the adjacent cell. In such a situation, a proper selection of an interference mitigation/rejection type of algorithm may substantially improve the performance.

One particular embodiment of the invention is to identify the situation where the addition of receive changes and to select and activate the preferred more advanced algorithm substantially improving the performance. Criterion of adding cells/sectors to the local receive active set would depend on chosen or available receive algorithms and probably the UE bit rate or the UE service to be granted. In the invention, the adding/removing criteria are dependent of the specific user scenario as well. One example is when the received power level is high and the performance mainly are limited by other user interface, then it is of interest to set the criteria to add/remove a cell/sector with relative power offset to the already connected cells/sectors to be large, e.g. −10 dB. On the other hand, if the received power is low and the performance mainly are power limited, and then it may only be of interest to set the criteria to add/remove a cell/sector with small relative power offset, e.g. −3 dB.

Power control target may also be set dependent of receive algorithms. E.g. to have reliable interference cancellation on a certain kind of UEs, e.g. very high bit rate UEs, the power control targets (in terms of QoS) for these UEs can be higher.

The EUL scheduler with knowledge in the RBS that the concerned UE having improved detection quality, may give/schedule higher data rate grant to that UE which may result in higher data throughput. Alternatively, by keeping the same data rate granted but lowering the UE output power level may improve system capacity by lower noise raise making potential for admitting further/other UE transmission(s).

An arrangement 1 for radio link handling according to the present invention will be described with reference to FIG. 6. The arrangement 1 is typically located in a radio base station BS in a telecommunication system, wherein the radio base station BS supports a plurality of mobile user equipment UE and comprise a plurality of antenna arrangements AA each associated with a respective determined cell coverage area. The arrangement 1 further comprises a unit for actively determining 200 a respective local receive active set of cells or antennas for each of at least a subset of the plurality of mobile user equipment UE, a receiving unit for receiving and detecting 300 signals from each mobile user equipment UE jointly utilizing each determined local receive active set.

I addition, the arrangement 1 includes a unit 100 for locally determining a metric/parameter or set of metrics/parameters, for all cells associated with the base station BS, and the active determining unit 200 is configured to determined the local receive active set for each UE based on the locally determined metric(s)/parameter(s). Further, the determining unit 200 includes or is associated with a unit 210 for comparing the determined metric(s)/parameter(s) with a predetermined threshold and a unit 220 for configuring the local active receive set depending on that comparison.

The radio base station can be a Node B, eNodeB, a base transceiver station BTS, or similar node. Further, the invention is applicable to a variety of receivers located in the base station, such as e.g. RAKE, EQ, MMSE, GRAKE etc. Even advanced receivers such as IC, MUD, decision feedback EQ, Turbo EQ, etc benefit from the invention.

A further embodiment of the method (and arrangement) of the present invention comprises a step of, for each UE associated with the base station, adaptively selecting at least one of a plurality of available receiver algorithms in the base station, based on at least the determined parameter(s) and/or metric(s).

### ADVANTAGES OF THE PRESENT INVENTION INCLUDE

An uplink dedicated technique with functionality configured within the radio base station (Node B, eNB, BTS etc). There is no involvement in higher nodes like RNC, MME or BSC, though it might be beneficial to report the resource usage to higher nodes. The applicable sites include multi-cells with overlay antenna diagrams (patterns).

Main targets are EUL/HSUPA/HSPA/LTE high data rate scheduled channels.

One benefit is an improved data coverage for specific directions within the service area, independent of used service (data rate) of the UEs as a consequence of the increased diversity gain.

The technique increases spatial diversity and/or improves spatial interference suppression/cancellation, without need of adding extra radio HW resources. Consequently, the embodiments of the present invention improve received performance for high bit rates and/or user capacity and/or coverage and/or cell edge bit rates.

The adaptive selection process of which UEs to enable more advanced receivers is beneficial for reducing the total complexity of the RBS. This is due to the fact that the higher complexity algorithms can be used for UE signal reception on a need basis and availability resources. An alternative is to provide this more complex algorithms to all UEs resulting in very complex and costly processing requirements of the RBS.

It will be understood by those skilled in the art that various modifications and changes may be made to the present invention without departure from the scope thereof, which is defined by the appended claims.

1.-19. (canceled)

20. A method of radio link handling in a radio base station (RBS) in a telecommunication system, the RBS supporting a plurality of user equipments (UEs) and comprising a plurality of antenna arrangements, each associated with a respective determined cell coverage area, comprising:
actively determining, in the RBS, a respective local uplink receive active set of cells or antennas in the RBS for each of at least a subset of the plurality of UEs, based on received uplink signals on all cells; and
receiving and detecting signals from each UE jointly utilizing each determined local uplink receive active set.

21. The method of claim 20, further comprising locally determining, for all cells, at least one parameter for at least the subset of the plurality of UEs, and actively determining the respective local uplink receive active set of cells or antennas for each of the UEs of the subset based on the at least one parameter.

22. The method of claim 20, further comprising locally determining, for all cells, at least one metric for at least the subset of the plurality of UEs, and actively determining the respective local uplink receive active set of cells or antennas for each of the UEs of the subset based on the at least one metric.

23. The method of claim 22, wherein actively determining the respective local uplink receive active set comprises:
comparing the at least one metric for each cell and UE with a predetermined threshold value, and
configuring the local uplink receive active set based on the comparing.

24. The method of claim 23, wherein configuring the local uplink receive active set comprises adding a cell to the local uplink receive active set if the cell's respective at least one metric exceeds the predetermined threshold value, and removing a cell from local uplink receive active set if the cell's respective at least one metric does not exceed the predetermined threshold value.

25. The method of claim 22, wherein locally determining is performed continuously.

26. The method of claim 25, wherein actively determining is performed at least once every transmission time interval.

27. The method of claim 22, wherein locally determining is performed aperiodically.

28. The method of claim 22, wherein locally determining is performed periodically.

29. The method of claim 22, wherein locally determining is performed on demand.

30. The method of claim 22, wherein the at least one metric for a specific UE is actively determined in response to a predetermined criterion.

31. The method of claim 22, further comprising locally measuring the at least one metric based on a received uplink signal.

32. The method of claim 22, wherein the at least one metric includes at least one of signal to noise ratio, signal to interference ratio, received signal strength, and interference power level.

33. The method of claim 20, further comprising reporting the determined local uplink receive active set for each UE to a node in the system.

34. The method of claim 20, further comprising, for each UE, adaptively selecting one of a plurality of available receiver algorithms.

35. An arrangement for radio link handling in a radio base station (RBS) in a telecommunication system, the RBS supporting a plurality of user equipments (UEs) and having a plurality of antenna arrangements, each associated with a respective determined cell coverage area, the arrangement comprising:
a determining unit adapted to actively determine a respective local uplink receive active set of cells or antennas for each of at least a subset of the plurality of UEs based on received uplink signals on all cells; and
a receiving unit adapted to receive and detect signals from each UE jointly utilizing each local uplink receive active set.

36. The arrangement of claim 35, further comprising a locally determining unit configured for locally determining, for all cells, at least one metric based on a received uplink signal for at least the subset of the plurality of UEs, wherein the determining unit is adapted to actively determine the respective local uplink receive active set of cells or antennas for each UE of the subset based on the at least one metric.

37. The arrangement of claim 35, wherein the determining unit further comprises:
a comparing unit adapted for comparing the at least one metric for each cell and UE with a predetermined threshold value, and
a configuring unit adapted for configuring the local uplink receive active set based on comparing by the comparing unit.

38. The arrangement of claim 35, wherein the arrangement is adapted to adaptively select one of a plurality of available receiver algorithms for each UE.
